(19) United States
(12) Patent Application Publication
(10) Pub. No.: US 2018/0230955 A1
(43) Pub. Date: Aug. 16, 2018

(54) Electromagnetic Switching Valve and High-Pressure Fuel Pump

(71) Applicant: CONTINENTAL AUTOMOTIVE GMBH, Hannover (DE)

(72) Inventors: Matthias Bleeck, Litzlweg (DE); Bernd Gugel, Regensburg (DE); Andreas Mühlbauer, Bernhardswald (DE); Henry Meissgeier, Roding (DE)

(73) Assignee: CONTINENTAL AUTOMOTIVE GMBH, Hannover (DE)

(21) Appl. No.: 15/897,398

(22) Filed: Feb. 15, 2018

(30) Foreign Application Priority Data
Feb. 15, 2017 (EP) 17156169.9

(51) Int. Cl. F02M 59/36; F02M 63/00; F16K 31/06; F02M 59/46; F02M 51/06

(52) U.S. Cl. CPC F02M 59/368; F02M 63/0022; F16K 31/0644; F02M 59/466; H01F 7/08; F02M 51/0614; F02B 2275/14; F02M 2200/09; F02M 51/0682

(57) ABSTRACT

The invention relates to an electromagnetic switching valve for a fuel-injection system of an internal-combustion engine, which has an actuator region, for moving a closing element, with a pole piece and with an armature and also with a solenoid for generating a magnetic flux in the armature and the pole piece, said armature having a region of magnetic-flux concentration.

### CROSS-REFERENCE TO RELATED APPLICATIONS

This application claims the benefit of European Application EP 17156169, filed Feb. 15, 2017. The disclosures of the above application is incorporated herein by reference.

### TECHNICAL FIELD

The disclosure relates to an electromagnetic switching valve for a fuel-injection system of an internal-combustion engine, and to a high-pressure fuel pump that has such an electromagnetic switching valve.

### BACKGROUND

High-pressure fuel pumps in fuel-injection systems in internal-combustion engines are used for applying a high pressure to a fuel, the pressure being, for example, within the range from 150 bar to 400 bar in the case of gasoline internal-combustion engines, and within the range from 1500 bar to 2500 bar in the case of diesel internal-combustion engines. The higher the pressure that can be generated in the respective fuel, the lower the emissions are that arise during the combustion of the fuel in a combustion chamber, this being advantageous, in particular, against the background that a diminution of emissions is desired to an ever greater extent.

Valve arrangements may be provided in the fuel-injection system at various positions of the path that the fuel takes from a tank to the respective combustion chamber, for example, by way of inlet valve or outlet valve on a high-pressure fuel pump that pressurizes the fuel, but also, for example, by way of relief valve at various positions in the fuel-injection system, for example on a common rail which stores the pressurized fuel prior to injection into the combustion chamber.

Fast-switching magnetic valves for volume-flow regulation and/or pressure regulation are frequently used for this purpose. Depending on the delivery-rate and type, a return spring keeps a closing element of a valve region of such an electromagnetic switching valve open or closed to a volume flow. The associated actuator region—that is to say, the magnetic actuator which opens or closes the closing element—is configured such that the return spring is able to out-press the actuator force of the magnetic actuator in a certain time, consequently to switch the switching valve.

These switching valves are accordingly constructed as a combination of a switching magnet, which operates the magnetic actuator, with hydraulics switched by the actuator—the valve region. In operation, two switching-states of the hydraulics are consequently obtained: an open position and a closed position.

In the actuator region the switching magnet has components separated by a force-generating air gap, namely a mobile armature and a fixed pole core, which are kept spaced apart from one another by the return spring. By the activation of a solenoid in the switching magnet by application of electric current, a magnetic field is built up in a winding of the solenoid. This magnetic field induces a magnetic flux in the surrounding metal components, particularly in the armature and in the pole core, so that a magnetic force is built up between the armature and the pole core. Due to this magnetic force, a restoring force of the return spring is overcome, and the coupled hydraulics are controlled. As a result of the electric current being taken away, the magnetic force drops, and the restoring force controls the hydraulics into the initial position.

Previously, the dynamics of the switching valves were designed for the operating state in which the fastest switching characteristic in operation is needed. As a result, however, the impelling forces between the switching magnetic components, namely the armature and the pole core, become very high.

The switching valve has been designed in such a way that at the working point at which the maximal air gap between the armature and the pole core obtains, and at which an equilibrium of forces arises between the return spring and the magnetic force of the solenoid, a magnetic-flux density that is as high as possible arises in the air gap between the armature and the pole core, so that the moving components are excited to move as quickly as possible. Within the motion process, the moving components are then accelerated further by the magnetic force, and the air gap is reduced. In the state of the minimal air gap, the magnetic force is then maximal.

The impelling forces are dependent on the mass of the moving components and on the speed thereof. In the case of high impelling forces, the consequence is that a high wear may arise between the components, and the noises in operation are very loud. This is because noises arise with every alteration of the switching-state, both by the solenoid itself and by the hydraulics. At least two components strike one another and generate noises.

For example, such a switching valve is used as a digital inlet valve on a high-pressure fuel pump in a fuel-injection system of an internal-combustion engine. The switching-time of such an inlet valve is designed such that it is capable of switching quickly even at the highest engine speed of the internal-combustion engine. However, this is in contrast with the objective that in another operating state of the internal-combustion engine, namely when the engine is idling, no noticeable noises should be generated.

So far, the switching valve has been designed for the switching-time for the operating point having the highest switching dynamics. Attempts were made to intercept, with brief current impulses for increasing the magnetic force, noises and wear in respect of movements that are directed contrary to the switching-direction of the switching magnet. However, it is difficult to attenuate movements in the switching-direction of the switching valve.

### SUMMARY

The disclosure provides an electromagnetic switching valve in which an evolution of noise can be reduced to a minimum at all operating points.

An electromagnetic switching valve for a fuel-injection system of an internal-combustion engine has a valve region, with a closing element for closing the switching valve, and an actuator region, for moving the closing element along an axis of motion. The actuator region includes an armature, which is mobile along the axis of motion and which for the purpose of moving the closing element is coupled with the closing element, a fixed pole piece, and a solenoid for generating a magnetic flux in the armature and in the pole piece. The armature has a region of magnetic-flux concentration.

The region of magnetic-flux concentration is formed by an outer periphery of the armature having a shoulder, so that the armature has a first outer periphery and a second outer periphery, which are different. In this connection, the first outer periphery of the armature is less than the second outer periphery of the armature. In some examples, the first outer periphery of the armature amounting is at most ¾ of the second outer periphery of the armature.

As a result, the outer periphery of the armature is reduced at the shoulder, and the magnetic-field lines that flow through the armature have to share the space with one another in this narrowed region. As a result, a concentration of the magnetic-field lines, and consequently of the magnetic flux, occurs in this region of the armature. Due to this constriction, the magnetic throttle is then formed as described above.

The first outer periphery of the armature along the axis of motion amounts substantially to one half of the total length of the armature.

The armature and the pole piece are arranged adjacent to one another, the region of the armature with the first outer periphery being arranged facing toward the pole piece.

Accordingly, the shoulder in the armature is arranged at a defined height and with a defined diameter and a defined length, to be able to obtain a defined concentration of magnetic flux in the armature.

Due to the constriction, the following effects arise overall:

The constriction is not only a concentration of magnetic flux obtained in the armature, but also the mass of the armature is reduced overall. In addition, the desired magnetic force is obtained more quickly than previously, this being associated with a reduction of the switching-time of the switching valve. At the same time, the armature is not accelerated so much in the motion phase, in which connection the speed nevertheless corresponds to that known previously. Overall, the total switching-time is reduced and consequently improved.

In some examples, an armature surface and a pole-piece surface are situated directly opposite one another. The surface area of the armature in the region of the first outer periphery of the armature amounting approximately to one half of the surface area of the pole piece.

In some implementations, the pole piece has a constriction in an outer periphery for forming a region of magnetic-flux concentration.

As a result, a concentration of magnetic flux in the pole piece can also be obtained, once again resulting in an improved switching-time of the switching valve.

In this case, the constriction is arranged in a half of the pole piece facing toward the armature, the constriction amounting, for example, to at least ⅕ of the total length of the pole piece along the axis of motion.

In some implementations, the outer periphery of the pole piece in the region of the constriction is reduced by at least ¼.

Accordingly, the constriction is arranged at a defined height in the pole piece and with a defined diameter and a defined length, to be able to obtain a defined concentration of magnetic flux in the pole piece.

In some implementations, the constriction of the pole piece along the axis of motion is located at the level of a recess of a return spring between the pole piece and the armature.

The constriction along the axis of motion may be located at the level of the solenoid.

A high-pressure fuel pump for a fuel-injection system of an internal-combustion engine may have an electromagnetic switching valve as described above.

In this case, the switching valve may have been formed, for instance, as an inlet valve for the high-pressure fuel pump or even as an outlet valve. However, it is also possible to provide the described switching valve as a pressure-regulating valve which, for instance, is arranged on a common rail of a fuel-injection system.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary fuel-injection system of an internal-combustion engine, which at various positions may have an electromagnetic switching valve.

FIG. 2 is a longitudinal-sectional view of one of the switching valves from FIG. 1 as an inlet valve on the high-pressure fuel pump.

FIG. 3 a longitudinal-sectional view of the switching valve from FIG. 2 with magnetic-field lines acting in operation.

FIG. 4 a longitudinal-sectional view of one of the switching valves from FIG. 1 as an inlet valve on the high-pressure fuel.

FIG. 5 a longitudinal-sectional view of the switching valve from FIG. 4 with magnetic-field lines acting in operation.

FIG. 6 a diagram that illustrates the magnetic force, acting in operation, of the switching valves from FIG. 2 and FIG. 4 against the magnetic excitation by the solenoid.

Like reference symbols in the various drawings indicate like elements.

### DETAILED DESCRIPTION

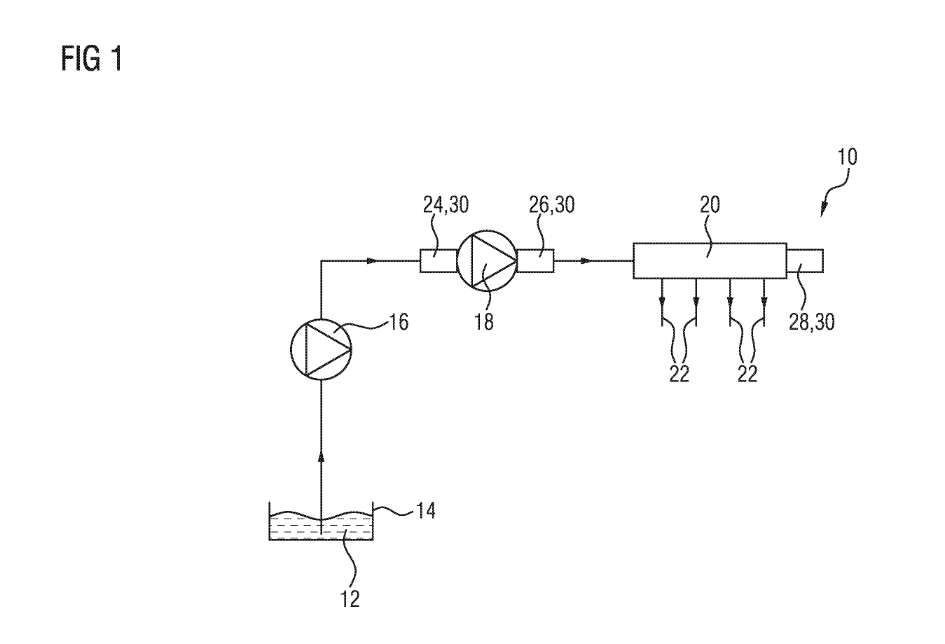

FIG. 1 shows a schematic overview of a fuel-injection system 10 of an internal-combustion engine, which feeds a fuel 12 from a tank 14, via a preliminary-feed pump 16, a high-pressure fuel pump 18 and a high-pressure fuel reservoir 20, to injectors 22 which then inject the fuel 12 into combustion chambers of the internal-combustion engine.

The fuel 12 is introduced into the high-pressure fuel pump 18 via an inlet valve 24, discharged from the high-pressure fuel pump 18 in a pressurized state via an outlet valve 26, and then supplied to the high-pressure fuel reservoir 20. A pressure-regulating valve 28 is arranged on the high-pressure fuel reservoir 20, to regulate the pressure of the fuel 12 in the high-pressure fuel reservoir 20.

The inlet valve 24 and the outlet valve 26, as well as the pressure-regulating valve 28 may be electromagnetic switching valves 30 and may therefore be operated actively.

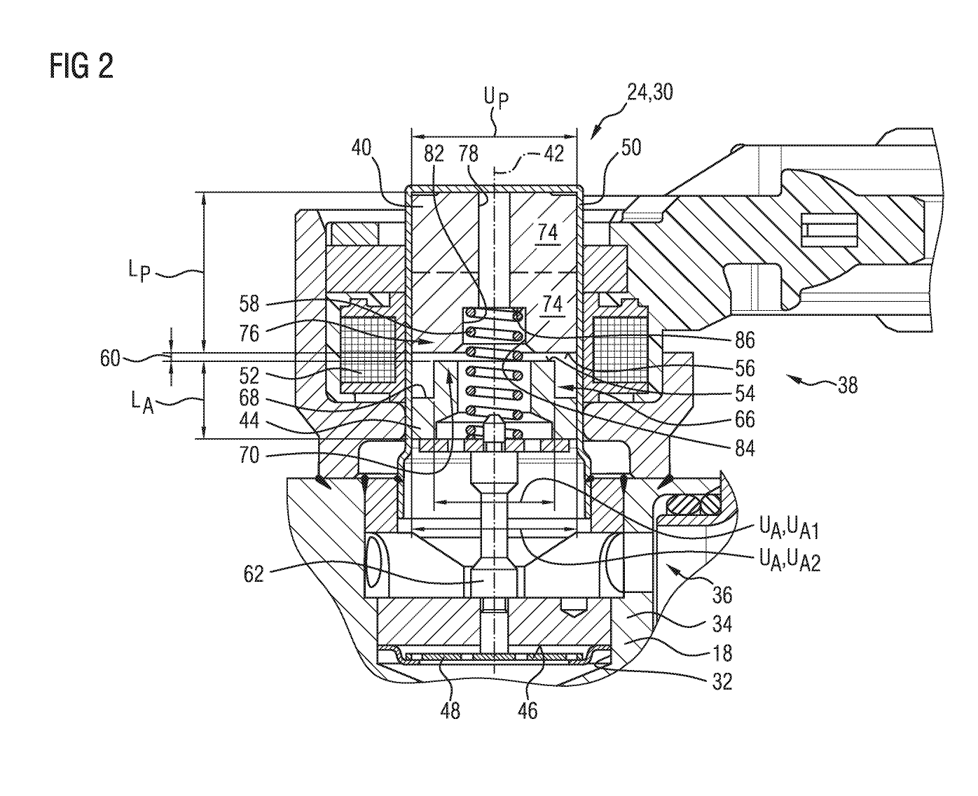

FIG. 2 shows a first example of an electromagnetic switching valve 30 in a longitudinal-sectional view through the electromagnetic switching valve 30 which takes the form of an inlet valve 24 of a high-pressure fuel pump 18.

The electromagnetic switching valve 30 is arranged in a bore 32 of a housing 34 of the high-pressure fuel pump 18. The electromagnetic switching valve 30 has a valve region 36 and an actuator region 38. The actuator region 38 has a fixed pole piece 40 and an armature 44 which is mobile along an axis of motion 42. The valve region 36 includes a valve seat 46 and a closing element 48, which interact for the purpose of closing the electromagnetic switching valve 30.

As shown in FIG. 2, the pole piece 40 and the armature 44 are jointly received in a sleeve 50, but this does not necessarily have to be the case.

A solenoid 52 is pushed onto the sleeve 50 and is consequently located around the pole piece 40 and the armature 44 disposed in the electromagnetic switching valve 30.

The armature 44 and the pole piece 40 are arranged directly adjacent to one another, so that an armature surface 54 and a pole-piece surface 56 are situated directly opposite one another.

A return spring 58 is arranged between the armature 44 and the pole piece 40, in order to keep the armature 44 and the pole piece 40 spaced apart and consequently to generate an air gap 60.

The armature 44 is coupled with an actuating pin 62 which in operation moves with the armature 44 along the axis of motion 42.

Depending upon the switching-state and consequently the position of the armature 44 along the axis of motion 42, the actuating pin 62 presses the closing element 48 away from the valve seat 46 or has no contact with the closing element 48, so that the latter, if a force is acting from the opposing side, can move toward the valve seat 46 and consequently close the switching valve 30.

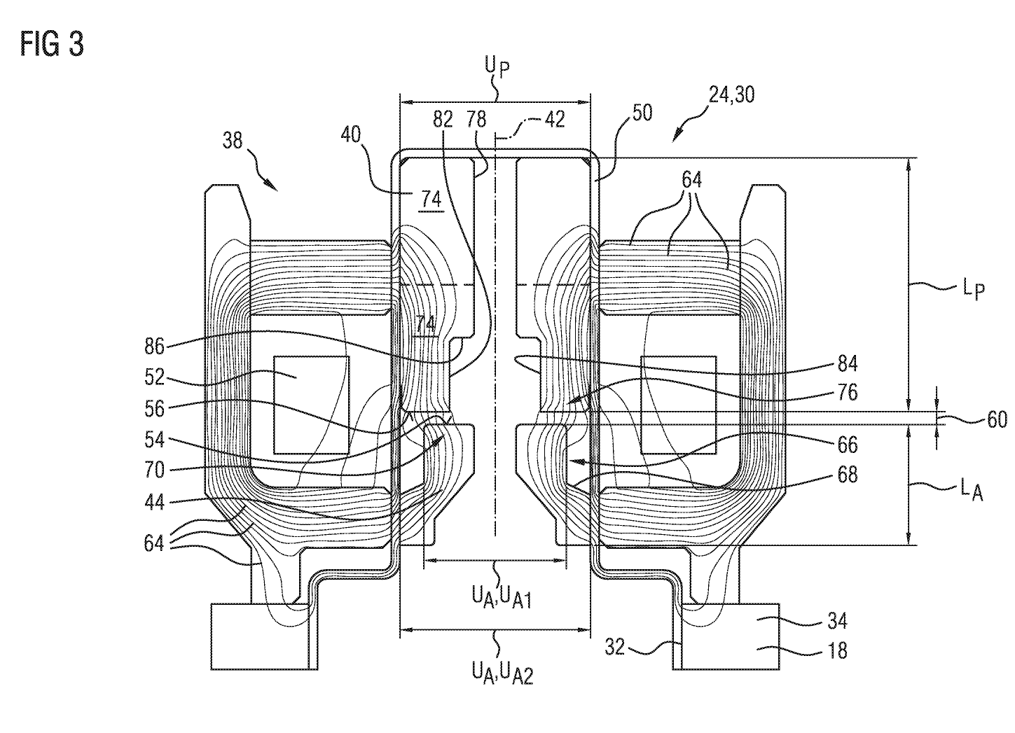

In the energized state of the electromagnetic switching valve 30, the solenoid 42 generates a magnetic field in the electromagnetic switching valve 30, which is represented in FIG. 3 by magnetic-field lines 64. As shown in FIG. 3, the magnetic flux of the magnetic-field lines 64 is arranged in all the metallic/magnetic elements directly adjacent to the solenoid 52, for example, in the pole piece 40 and in the armature 44. As a result, a magnetic force of attraction arises between the pole piece 40 and the armature 44, and the armature 44 with its surface 54 is pulled in the direction of the surface 56 of the pole piece 40. In this process, the armature 44 entrains the actuating pin 62, so that the latter loses contact with the closing element 48, and in this way the closing element 48 can return to the valve seat 46.

Since the armature 44 moves toward the pole piece 40 when the solenoid 52 has been switched on, in the switched-on state the air gap 60 is minimal.

In the switched-off state, on the other hand, the return spring 58 presses the armature 44 away from the pole piece 40 again, since a restoring force of the return spring 58 acts contrary to the magnetic force. The air gap 60 becomes maximal, and the actuating pin 62 is again pressed onto the closing element 48, so that the closing element 48 lifts away from the valve seat 46 and opens the electromagnetic switching valve 30.

As shown in FIG. 2 and FIG. 3, the armature 44 has a region of magnetic-flux concentration 66—that is to say, a region in which the magnetic-field lines are guided through the armature 44 over a diminished cross-sectional area, so that they must be concentrated.

The region of magnetic-flux concentration 66 is formed by an outer periphery UA of the armature having a shoulder 68, so that a first outer periphery UA1 of the armature and a second outer periphery UA2 of the armature, which are different from one another, are formed. The first outer periphery UA1 of the armature being less than the second outer periphery UA2 of the armature.

It can be seen that the armature 44 has the first outer periphery UA1 in the region in which the armature 44 is arranged directly adjacent to the pole piece 40—that is to say, at its upper end region 70.

The first outer periphery UA1 of the armature may amounts to at most ¾ of the second outer periphery UA2 of the armature. In addition, the length of the first outer periphery UA1 of the armature along the axis of motion 42 may amount to substantially one half of the total length LA of the armature 44.

Due to this arrangement of the reduced first outer periphery UA1 of the armature, a selective magnetic throttle can be generated in the armature 44, in order to obtain the advantages described above. The course of the magnetic-field lines 64 in this case is shown in FIG. 3, where it can be seen that the magnetic-field lines 64 are concentrated in the region in which the outer periphery UA of the armature is reduced, so that the magnetic flux is concentrated here overall.

From FIG. 2 it is further evident that the armature surface 54, which faces toward the pole piece 40, is smaller at the upper end region 70 than the pole-piece surface 56 which is directed toward the armature 44. In this case, the armature surface area 54 constitutes approximately one half of the pole-piece surface area 56.

The two surfaces situated opposite one another, namely the armature surface 54 and the pole-piece surface 56, are the surfaces that generate the magnetic force between the armature 44 and the pole piece 40.

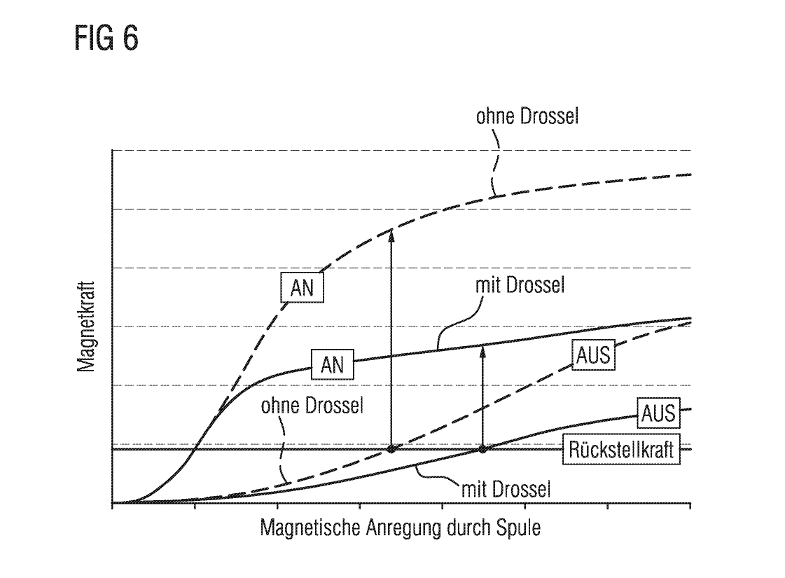

In the conventional design—that means, when the armature 44 has a constant outer periphery UA—a magnetic-flux density arises which on the armature surface 54 and on the pole-piece surface 56 lies approximately within the same range in value terms. However, the armature surface 54 and the pole-piece surface 56 are now designed to be of different sizes, so that, shortly after the magnetic force of the solenoid 52 has out-pressed the restoring force of the return spring 58, the magnetic flux reaches saturation, as will be explained later with reference to FIG. 6.

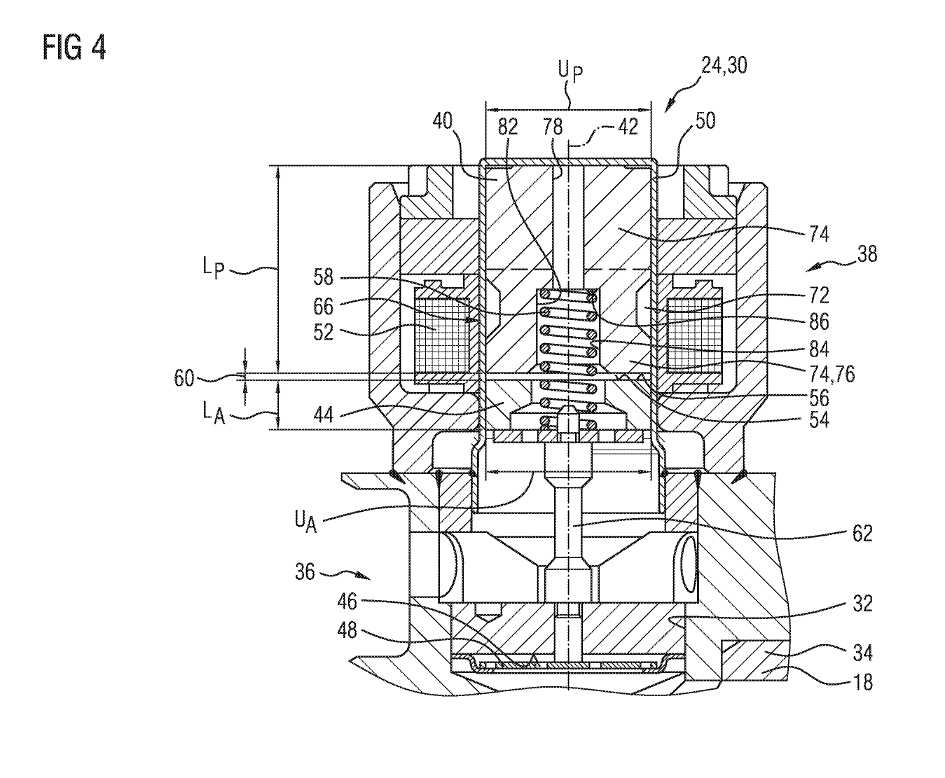

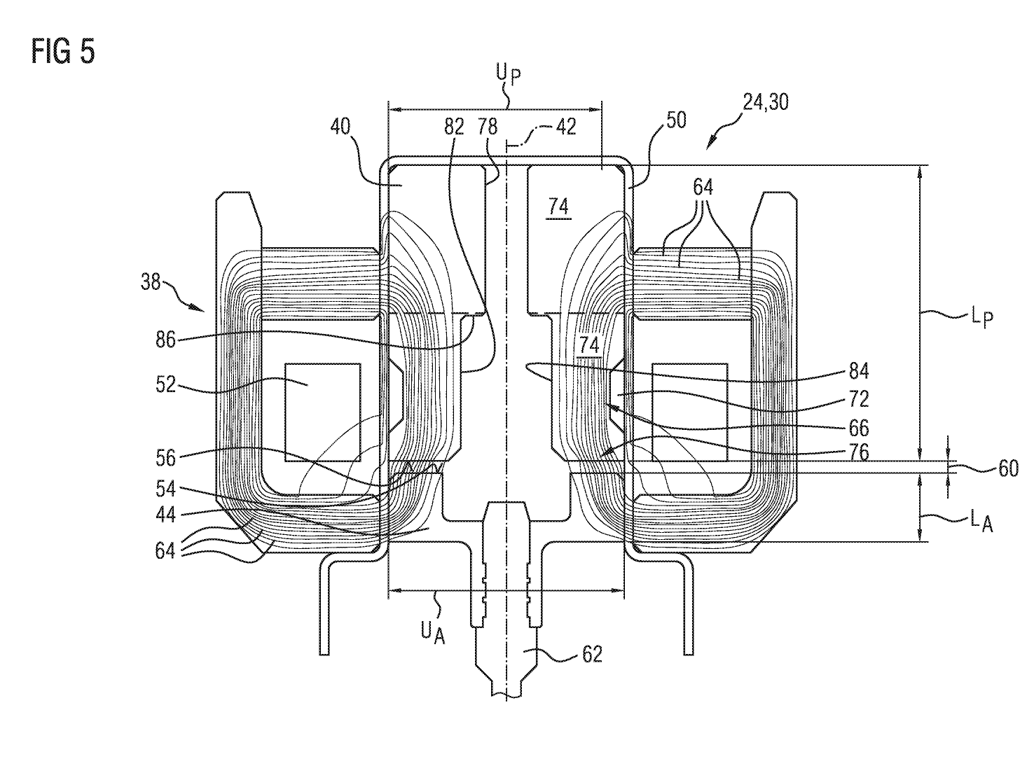

FIG. 4 and FIG. 5 show a second example of the electromagnetic switching valve 30, in which, by provision of the region of magnetic-flux concentration 66, the magnetic throttle is provided not in the armature 44, as in the first example, but in the pole piece 40.

However, it is also possible to combine the two examples, so that both the armature 44 and the pole piece 40 each form a region of magnetic-flux concentration 66 and consequently a magnetic throttle.

The region of magnetic-flux concentration 66 in the second example is formed by a constriction 72 in the pole piece 40, so that an outer periphery UP of the pole piece, which is otherwise constant over the axis of motion 42, is reduced in the region of the constriction 72.

The constriction 72 is arranged in a half 74 of the pole piece 40 that is arranged facing toward the armature 44, but not, as in the case of the armature 44 in the first example, at an end region, but rather spaced from an end region 76 of the pole piece. As a result, it is ensured that where the pole-piece surface 56 is adjacent to the armature surface 54, the maximal magnetic force from the pole piece 40 can act on the armature 44, in order to pull the armature 44 in the direction of the pole piece 40.

The constriction 72 has a length that corresponds to at least ⅕ of the length LP of the pole piece 40 along the axis of motion 42. The outer periphery UP of the pole piece is reduced in the region of the constriction 72 by at least ¼ in comparison with the constant outer periphery UP of the pole piece outside the constriction 72.

As can be seen in FIG. 4, FIG. 5, but also in FIG. 2 and FIG. 3, the return spring 58 is arranged in such a way that it is supported within the pole piece 40. For this purpose, the pole piece 40 has a through-bore 78 which widens in a lower pole-piece end region 78 which is arranged facing toward the armature 44, in order to form a spring recess 82. The spring recess 82 is defined by side walls 84 of the through-bore 78 and by supporting walls 68 which are formed by the widening of the through-bore 78 in the pole-piece end region 78. The return spring 58 is then supported on these supporting walls 68.

As can be seen in FIG. 4, the constriction 72 is formed along the axis of motion 42 at the level of the spring recess 82, for example, in such a way that it does not protrude beyond the spring recess 82. As a result, the concentration of magnetic flux can be achieved, for example, in the region of the return spring 58—that is to say, where the restoring force of the return spring 58 is also acting.

Furthermore, it can be seen that the constriction 72 is located also at the level of the solenoid 52 along the axis of motion 42.

The course of the magnetic-field lines 64 in the pole piece 40 is represented in FIG. 5, where it can be seen that the magnetic-field lines 64 are concentrated in the region of the constriction 72, and consequently a concentration of magnetic flux in the pole piece 40 can be generated. Hence the magnetic throttle generated in the armature 44 with reference to the first example can also be generated in the pole piece 40.

The mode of action of the magnetic throttles in the armature 44 and/or pole piece 40 will be explained in the following with reference to FIG. 6.

FIG. 6 shows a diagram that represents the magnetic force generated by the solenoid 52 and the magnetic flux acting in the armature 44 and in the pole piece 40 against the magnetic excitation by the solenoid 52.

The dashed lines correspond to the magnetic force acting in a known arrangement, in which the armature 44 and the pole piece 40 do not have a region of magnetic-flux concentration 66. The continuous lines, on the other hand, show the magnetic force acting in the case of a design of the armature 44 and of the pole piece 40 with magnetic-flux concentration.

The horizontal line in the diagram indicates the magnetic force to be generated by the solenoid 52 that is necessary in order to out-press the restoring force of the return spring 58, so that the armature 44 is set in motion.

The two lines that represent the process of switching the switching valve 30 on are labeled with “ON”.

The two lines that represent the process of switching the switching valve 30 off are labeled with “OFF”.

Overall, the diagram therefore shows, in each instance, a partial region of a hysteresis which occurs in the course of operation of the switching valve 30.

From the diagram it can be gathered that, when switching off in the absence of magnetic throttling in the armature 44 or in the pole piece 40, the magnetic force continues to rise considerably after out-pressing the restoring force, and barely reaches a saturation range. On the other hand, it can be seen that, when a magnetic throttling obtains at the armature 44 or at the pole piece 40, shortly after out-pressing the restoring force of the return spring 58, the magnetic force enters a saturation range and does not rise further. Consequently a diminished acceleration of the armature 44 is brought about in the motion phase, so that the impulse upon impact of the armature 44 into the pole piece 40 is then also reduced. The evolution of noise when switching on the switching valve 30 can consequently be distinctly reduced.

When switching off, it can be discerned that when a magnetic throttle obtains in the armature 44 or in the pole piece 40, the magnetic force returns earlier to the point at which the equilibrium of forces with the restoring force of the return spring 58 arises than is the case when the magnetic throttle does not obtain.

This means the process of switching off the switching valve 30 is faster than was the case previously. As a result, the overall switching-time of the switching valve 30 is distinctly reduced and consequently improved in relation to the state of the art.

Although, as can be seen from the diagram in FIG. 6, the magnetic force is also reduced overall by the magnetic throttle, this can be compensated by appropriate winding-parameters in the solenoid 52 if there is a demand for this. It would also be possible to readjust this via the electrical resistance which influences the current in the solenoid 52.

A number of implementations have been described. Nevertheless, it will be understood that various modifications may be made without departing from the spirit and scope of the disclosure. Accordingly, other implementations are within the scope of the following claims.

What is claimed is:

1. An electromagnetic switching valve for a fuel-injection system of an internal-combustion engine, the switching valve comprising:
a valve region with a closing element for closing the switching valve; and
an actuator region for moving the closing element along an axis of motion, the actuator region including:
an armature, which is mobile along the axis of motion and is coupled with the closing element to move the closing element, the armature has a region of magnetic-flux concentration;
a fixed pole piece; and
a solenoid for generating a magnetic flux in the armature and in the pole piece.

2. The electromagnetic switching valve of claim 1, wherein the region of magnetic-flux concentration is defined by an outer periphery of the armature having a shoulder, so that the armature has a first outer periphery and a second outer periphery, the first outer periphery having a length different than a length of the second outer periphery.

3. The electromagnetic switching valve of claim 2, wherein the first outer periphery of the armature is less than the second outer periphery of the armature.

4. The electromagnetic switching valve of claim 3, wherein the first outer periphery of the armature is equal to or less than ¾ of the second outer periphery of the armature.

5. The electromagnetic switching valve of claim 3, wherein the first outer periphery of the armature along the axis of motion is equal to one half of a total length of the armature.

6. The electromagnetic switching valve of claim 2, wherein the armature and the pole piece are arranged adjacent to one another, the region of the armature having the first outer periphery of the armature arranged facing toward the pole piece.

7. The electromagnetic switching valve of claim 6, further comprising an armature surface and a pole-piece surface situated directly opposite one another, an armature surface area of the armature surface in the region of the first outer periphery of the armature amounting to approximately one half of a pole-piece surface area of the pole-piece.

8. The electromagnetic switching valve of claim 1, wherein the pole piece has a constriction in an outer periphery for forming a region of magnetic-flux concentration.

9. The electromagnetic switching valve of claim 8, wherein the constriction is arranged in a half of the pole piece facing toward the armature.

10. The electromagnetic switching valve of claim 8, wherein the constriction amounting to at least ⅕ of a total length of the pole piece along the axis of motion, and the outer periphery of the pole piece in the region of the constriction being reduced, by at least ¼.

11. A high-pressure fuel pump for a fuel-injection system of an internal-combustion engine, having an electromagnetic switching valve as claimed in one of claims 1 to 8.
